(19) United States
(12) Patent Application Publication
(10) Pub. No.: US 2018/0063708 A1
(43) Pub. Date: Mar. 1, 2018

(54) APPARATUS AND METHOD FOR OPTIMIZING REMOTE AUTHENTICATION OF VIRTUAL SUBSCRIBER IDENTITY MODULE ON DUAL-SIM DUAL-STANDBY DEVICE

(71) Applicant: QUALCOMM Incorporated, San Diego, CA (US)

(72) Inventors: Yongsheng SHI, San Diego, CA (US); Abhishek BHATNAGAR, San Diego, CA (US); Eswar Kumar MOYYA, San Diego, CA (US); Uttam PATTANAYAK, San Diego, CA (US); Ajantha DE SILVA, San Diego, CA (US)

(21) Appl. No.: 15/246,322

(22) Filed: Aug. 24, 2016

(51) Int. Cl. H04W 12/06; H04L 29/06

(52) U.S. Cl. CPC H04W 12/06; H04L 63/18

(57) ABSTRACT

A method for optimizing remote authentication of a virtual subscriber identity module (VSIM) for a multi-subscriber identity module (SIM) multi-standby (MSMS) mobile communication device includes: receiving a VSIM authentication request from a VSIM network; determining whether a previous packet switched (PS) connection between the VSIM and the VSIM network is available; in response to determining that the previous PS connection between the VSIM and the VSIM network is available, performing VSIM authentication using the previous PS connection between the VSIM and the VSIM network.

### BACKGROUND

A Virtual-SIM (VSIM) is subscriber identity module (SIM) software that acts as a SIM interface with a mobile communication device. A physical SIM corresponding to the VSIM may be available at remote server. A physical SIM in the mobile communication device may be used to establish a packet switched (PS) connection for authenticating a VSIM. In a roaming area, the user may use the VSIM, which may belong to a local network operator, for PS calls, thereby avoiding expensive roaming charges. Remote authentication may also be used by a mobile virtual network operator (MVNO).

FIG. 4 is a diagram of a communication system 400 illustrating conventional remote authentication of a VSIM on a DSDS mobile communication device. Referring to FIG. 4, in addition to a physical SIM (e.g., the first SIM 140), a mobile communication device 100 may include a VSIM 160. The network provider may provide a VSIM application that may configure the VSIM 160 and may deactivate the one or more physical SIMs. The remote server may host a plurality of remote physical SIMs 260 including the remote physical SIM corresponding to the VSIM 160.

During mobility situations for the mobile communication device 100 after initial VSIM 160 authentication, the VSIM network 220 may require re-authentication of the VSIM 160. The VSIM network 220 may send an authentication request 422 to the VSIM 160 in the mobile communication device 100. Since the root key needed to calculate the authentication response resides in a remote VSIM server 250 the mobile communication device 100 may communicate with the VSIM server 250 to authenticate the VSIM 160. The VSIM 160 may pass the authentication request 422 to the physical SIM (i.e., the first SIM 140) and the physical SIM may communicate the authentication request 422 to the VSIM server 250 via a remote network 440. Alternatively, a soft-SIM application pre-embedded in the mobile communication device 100 may be used to communicate with the VSIM server 250 via the remote network 440.

However, in order to perform the authentication, the mobile communication device 100 tunes away to the remote network 440 using the physical SIM 140, performs a PS attach and registration with the physical SIM and establishes a PS radio access bearer (RAB) to send the authentication request 422 to and receive the authentication response 426 from the VSIM server 250. The mobile communication device 100 then tunes back to the VSIM network 220 to enable transmission of the authentication response 426.

The delay for performing these operations may be 3-10 seconds or more. If the authentication response is not received by the VSIM network 220 within six seconds after the VSIM network 220 sends the authentication request 422 a retry may be initiated. In a worst-case situation, the delay may cause a VSIM 160 radio link failure resulting in complete failure of the authentication procedure.

### SUMMARY

Apparatuses and methods for optimizing remote authentication of a VSIM for a dual-SIM dual-standby (DSDS) mobile communication device are provided.

According to various aspects there is provided a method for optimizing remote authentication of a virtual subscriber identity module (VSIM) for a multi-subscriber identity module (SIM) multi-standby (MSMS) mobile communication device. In some aspects, the method may include: receiving a VSIM authentication request from a VSIM network; determining whether a previous packet switched (PS) connection between the VSIM and the VSIM network is available; in response to determining that the previous PS connection between the VSIM and the VSIM network is available, performing VSIM authentication using the previous PS connection between the VSIM and the VSIM network.

According to various aspects there is provided a multi-subscriber identity module (SIM) multi-standby (MSMS) mobile communication device. In some aspects, the MSMS mobile communication device may include: a communication unit; at least one physical subscriber identity module (SIM); a virtual subscriber identity module (VSIM); and a control unit operably connected to the communication unit, the at least one physical SIM, and the VSIM.

The control unit may be configured to: receive a VSIM authentication request from a VSIM network; determine whether a previous packet switched (PS) connection between the VSIM and the VSIM network is available; in response to determining that the previous PS connection between the VSIM and the VSIM network is available, perform VSIM authentication using the previous PS connection between the VSIM and the VSIM network.

According to various aspects there is provided a non-transitory computer readable medium. In some aspects, the non-transitory computer readable medium may include instructions for causing one or more processors to execute a method for optimizing remote authentication of a virtual subscriber identity module (VSIM) for a multi-subscriber identity module (SIM) multi-standby (MSMS) mobile communication device, the program having operations including: receiving a VSIM authentication request from a VSIM network; determining whether a previous packet switched (PS) connection between the VSIM and the VSIM network is available; in response to determining that the previous PS connection between the VSIM and the VSIM network is available, performing VSIM authentication using the previous PS connection between the VSIM and the VSIM network.

According to various aspects there is provided a multi-subscriber identity module (SIM) multi-standby (MSMS) mobile communication device. In some aspects, the MSMS mobile communication device may include: means for receiving a VSIM authentication request from a VSIM network; means for determining whether a previous packet switched (PS) connection between the VSIM and the VSIM network is available; in response to determining that the previous PS connection between the VSIM and the VSIM network is available, means for performing VSIM authentication using the previous PS connection between the VSIM and the VSIM network.

Other features and advantages should be apparent from the following description which illustrates by way of example aspects of the various teachings of the disclosure.

### BRIEF DESCRIPTION OF THE DRAWINGS

Aspects and features of the various embodiments will be more apparent by describing examples with reference to the accompanying drawings, in which:

FIG. 1A is a block diagram illustrating a mobile communication device according to various examples;

FIG. 1B is a diagram illustrating a network environment for various examples;

FIG. 2 is a diagram of a communication system illustrating remote authentication of a VSIM on a DSDS mobile communication device according to various examples;

FIG. 3 is a flowchart illustrating a method for remote authentication of a VSIM on a DSDS mobile communication device according to various examples; and

FIG. 4 is a diagram of a communication system illustrating conventional remote authentication of a VSIM on a DSDS mobile communication device.

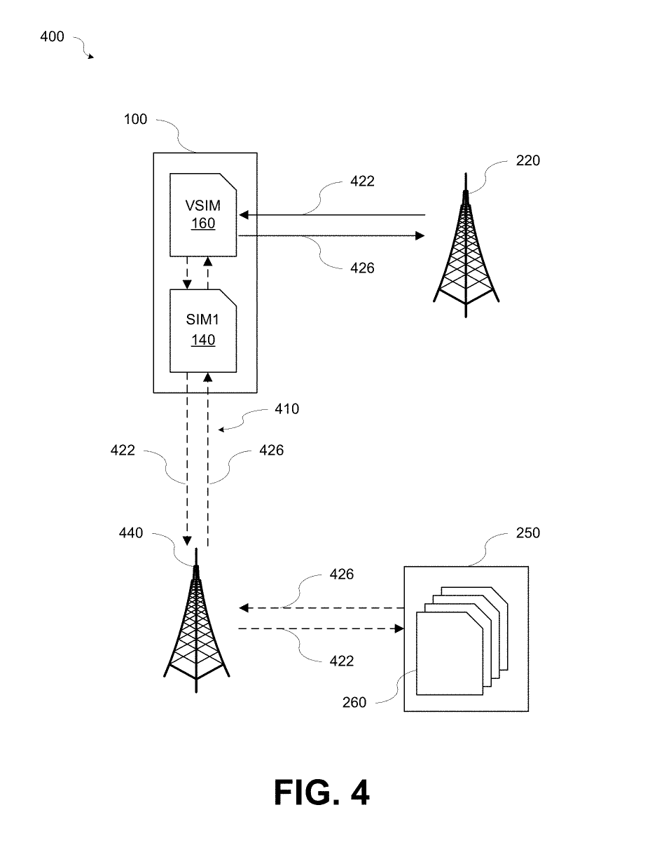

### DETAILED DESCRIPTION

While certain embodiments are described, these embodiments are presented by way of example only, and are not intended to limit the scope of protection. The apparatuses, methods, and systems described herein may be embodied in a variety of other forms. Furthermore, various omissions, substitutions, and changes in the form of the example methods and systems described herein may be made without departing from the scope of protection.

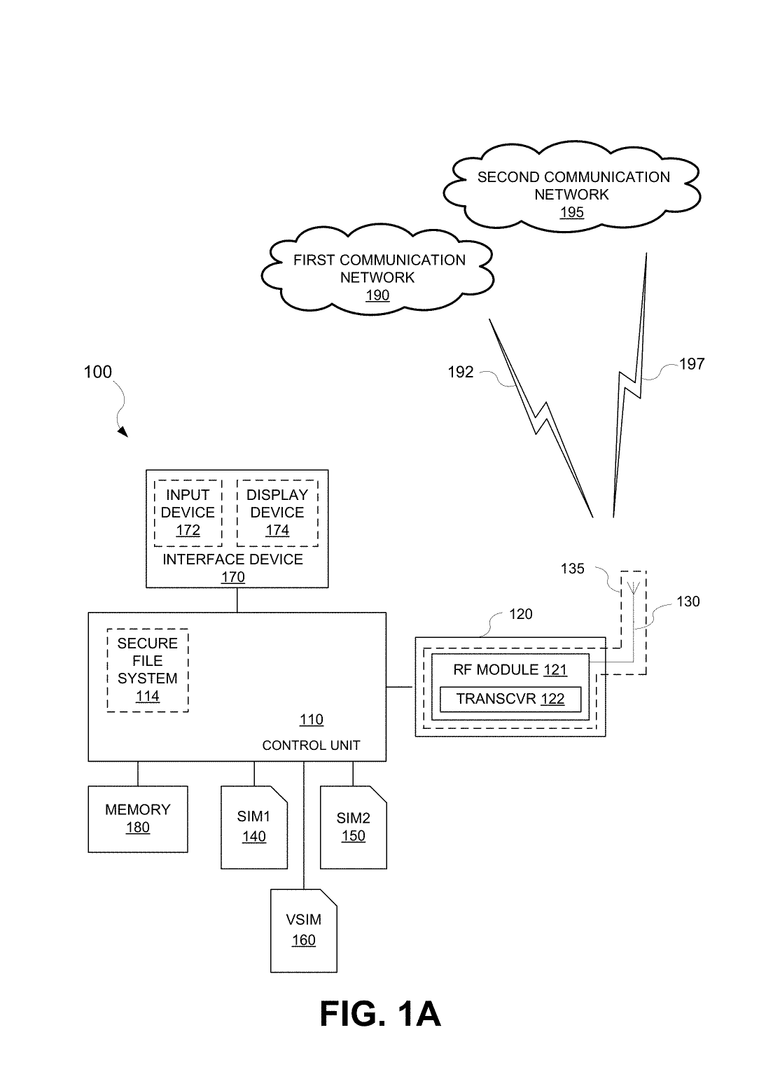

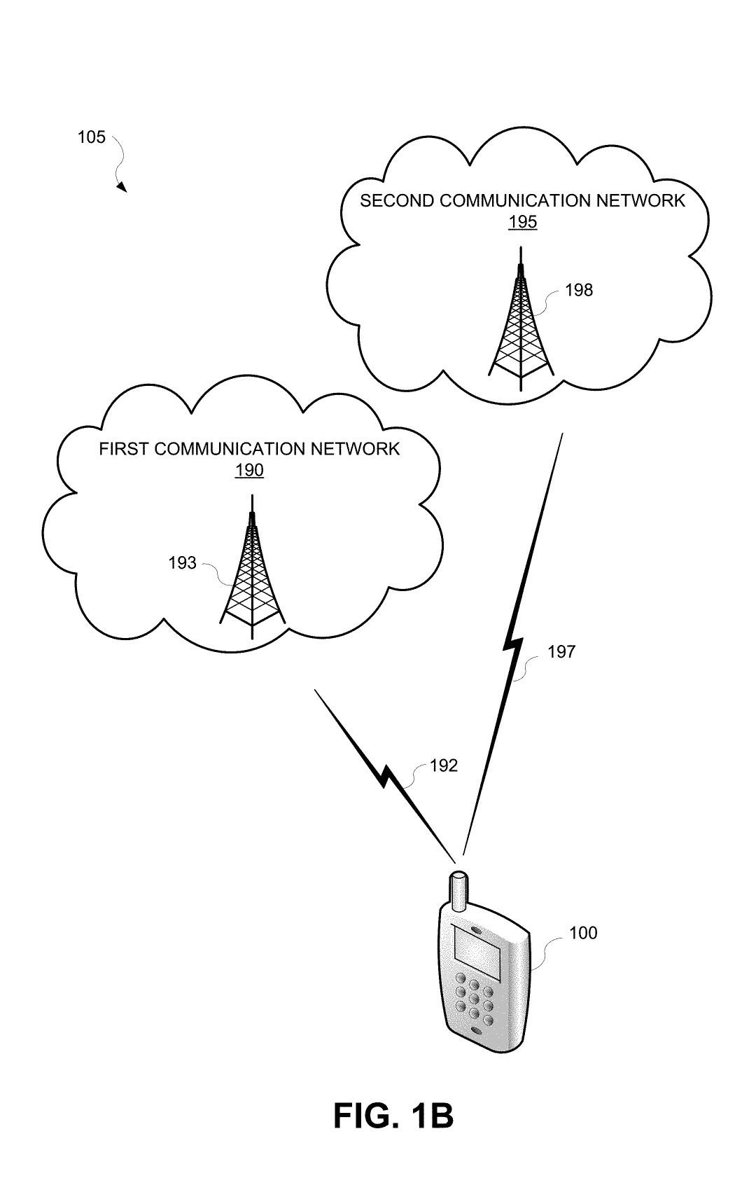

FIG. 1A is a block diagram illustrating a mobile communication device 100 according to various examples. As illustrated in FIG. 1A, the mobile communication device 100 may include a control unit 110, a communication unit 120, an antenna 130, a first subscriber identity module (SIM) 140, a second SIM 150, a user interface device 170, and a memory 180.

The mobile communication device 100 may be, for example but not limited to, a mobile telephone, smartphone, tablet, computer, etc., capable of communications with one or more wireless networks. One of ordinary skill in the art will appreciate that the mobile communication device 100 may include one or more communication units and may interface with one or more antennas without departing from the scope of protection.

The communication unit 120 may include, for example, but not limited to, an RF module 121. The RF module 121 may include, for example, but not limited to a transceiver 122. An RF chain 135 may include, for example, but not limited to the antenna 130 and the RF module 121.

One of ordinary skill in the art will appreciate that embodiments of the mobile communication device 100 may include more than one communication unit and/or more than one antenna without departing from the scope of protection.

A SIM (for example the first SIM 140 and/or the second SIM 150) in various embodiments may be a universal integrated circuit card (UICC) that is configured with SIM and/or universal SIM (USIM) applications, enabling access to global system for mobile communications (GSM) and/or universal mobile telecommunications system (UMTS) networks. The UICC may also provide storage for a phone book and other applications. Alternatively, in a code division multiple access (CDMA) network, a SIM may be a UICC removable user identity module (R-UIM) or a CDMA subscriber identity module (CSIM) on a card. A SIM card may have a CPU, ROM, RAM, EEPROM and I/O circuits. An integrated circuit card identity (ICCID) SIM serial number may be printed on the SIM card for identification. However, a SIM may be implemented within a portion of memory of the mobile communication device 100, and thus need not be a separate or removable circuit, chip, or card.

A SIM used in various embodiments may store user account information, an international mobile subscriber identity (IMSI), a set of SIM application toolkit (SAT) commands, and other network provisioning information, as well as provide storage space for phone book database of the user's contacts. As part of the network provisioning information, a SIM may store home identifiers (e.g., a system identification number (SID)/network identification number (NID) pair, a home public land mobile network (HPLMN) code, etc.) to indicate the SIM card network operator provider.

The first SIM 140 may associate the communication unit 120 with a first subscription (Sub1) 192 associated with a first radio access technology (RAT) on a first communication network 190 and the second SIM 150 may associate the communication unit 120 with a second subscription (Sub2) 197 associated with a second RAT on a second communication network 195. When a RAT is active, the communication unit 120 receives and transmits signals on the active RAT. When a RAT is idle, the communication unit 120 receives but does not transmit signals on the idle RAT.

In addition, the mobile communication device 100 may include a VSIM 160 maintained by a third-party (e.g., and original equipment manufacturer (OEM), an MVNO, a local network operator, etc.). The VSIM 160 may be used to enable calls (e.g., PS calls) on a local VSIM network thereby avoiding expensive roaming charges.

For convenience, the various embodiments are described in terms of DSDS mobile communication devices (e.g., using the first SIM 140 and the VSIM 160). However, one of ordinary skill in the art will appreciate that the various embodiments may be extended to Multi-SIM Multi-Standby (MSMS) and/or Multi-SIM Multi-Active (MSMA) mobile communication devices without departing from the scope of protection.

The first communication network 190 and the second communication network 195 may be operated by the same or different service providers, and/or may support the same or different RATs, for example, but not limited to, GSM, CDMA, wideband CDMA (WCDMA), and long term evolution (LTE).

The user interface device 170 may include an input device 172, for example, but not limited to a keyboard, touch panel, or other human interface device, and a display device 174, for example, but not limited to, a liquid crystal display (LCD), light emitting diode (LED) display, or other video display. One of ordinary skill in the art will appreciate that other input and display devices may be used without departing from the scope of the various embodiments.

The control unit 110 may be configured to control overall operation of the mobile communication device 100 including control of the communication unit 120, the user interface device 170, and the memoryl80. The control unit 110 may be a programmable device, for example, but not limited to, a microprocessor (e.g., general-purpose processor, baseband modem processor, etc.) or microcontroller.

The control unit 110 may include a secure file system 114 configured to store encrypted files and/or information, for example, but not limited to, a software subscriber identity module (soft-SIM). Alternatively, the secure file system 114 may reside in the memory 180.

The memory 180 may be configured to store operating systems and/or application programs for operation of the mobile communication device 100 that are executed by the control unit 110, as well as to store application data and user data.

FIG. 1B is a diagram illustrating a network environment 105 for various examples. Referring to FIGS. 1A and 1B, a mobile communication device 100 may be configured to communicate with a first communication network 190 on a first subscription 192 and a second communication network 195 on a second subscription 197. One of ordinary skill in the art will appreciate that the mobile communication device may configured to communicate with more than two communication networks and may communicate on more than two subscriptions without departing from the scope of protection.

The first communication network 190 and the second communication network 195 may implement the same or different radio access technologies (RATs). For example, the first communication network 190 may be a GSM network and the first subscription 192 may be a GSM subscription. The second communication network 195 may also be a GSM network. Alternatively, the second communication network 195 may implement another RAT including, for example, but not limited to, LTE, WCDMA, and Time Division-Synchronous Code Division Multiple Access (TD-SCDMA).

The first communication network 190 may include one or more base transceiver stations (BTSs) including, for example, but not limited to, a first BTS 193. The second communication network 195 may also include one or more BTSs, including, for example, but not limited to, a second BTS 198. A person having ordinary skill in the art will appreciate that the network environment 105 may include any number of communication networks, mobile communication devices, and BTSs without departing from the scope of the various embodiments.

The mobile communication device 100 may attempt to acquire the first communication network 190 and camp on the first BTS 193. The mobile communication device 100 may also attempt to acquire the second communication network 195 and camp on the second BTS 198. A person having ordinary skill in the art will appreciate that the acquisition of the first communication network 190 performed on the first subscription 192 may be independent of the acquisition of the second communication network 195 performed on the second subscription 197. Furthermore, the mobile communication device 100 may attempt to acquire the first communication network 190 on the first subscription 192 and the second communication network 195 on the second subscription 197.

Various examples may optimize remote authentication of a VSIM on a dual-SIM dual-standby (DSDS) mobile communication device. During mobility situations for the mobile communication device 100 after initial authentication of the VSIM 160, the VSIM network 220 may require re-authentication of the VSIM 160. According to various examples, when the VSIM 160 receives an authentication request from the VSIM network 220, the mobile communication device 100 may determine whether a previous PS connection for the VSIM 160 is still available, and if available, may use the previous PS connection for the VSIM 160 to send the authentication request to the VSIM server 250 which may be remote from the VSIM network 220.

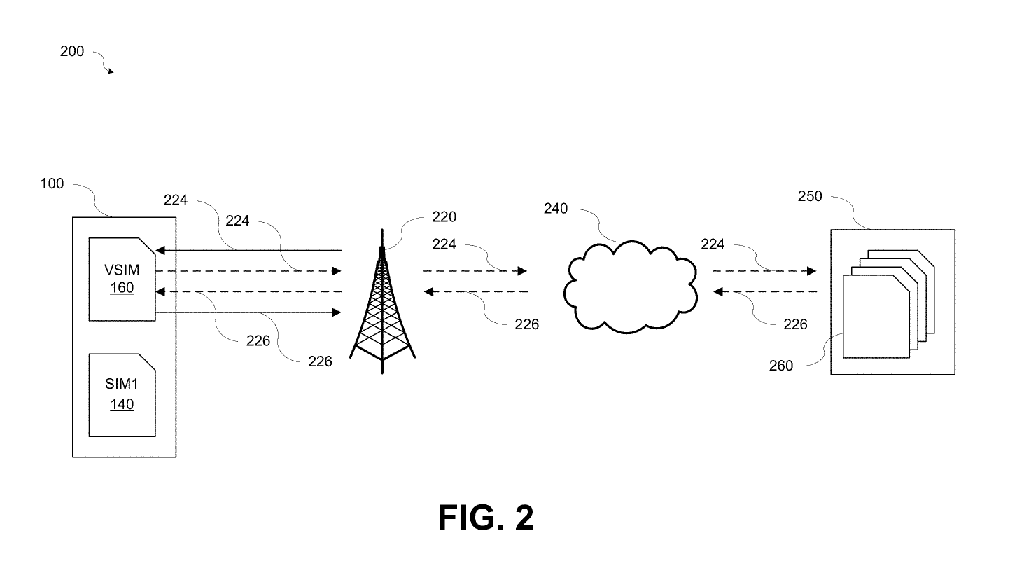

FIG. 2 is a diagram of a communication system 200 illustrating remote authentication of a VSIM on a DSDS mobile communication device according to various examples. In various examples, the mobile communication device 100 may be a multi-SIM multi-standby (MSMS) mobile communication device. In addition to physical SIMs (e.g., the first SIM 140 and the second SIM 150), the mobile communication device may include a VSIM 160. The network provider may provide a VSIM application that may configure the VSIM 160 and may deactivate the one or more physical SIMs.

Referring to FIG. 2, during mobility situations for the mobile communication device 100 after initial authentication of the VSIM 160, the VSIM network 220 may send an authentication request 224 to the mobile communication device 100. The mobile communication device 100 may receive the authentication request 224 for the VSIM 160 and determine whether a previous PS connection for the VSIM 160 is still active. For example, the mobile communication device 100 may attempt to “ping” (i.e., perform a handshake with) the VSIM server 250 to determine if the previous PS connection is still active or may attempt to directly send the authentication request 224 to the VSIM server 250.

If the previous PS connection for the VSIM 160 is still active, the mobile communication device 100 may use the previous PS connection for the VSIM 160 to transmit the authentication request 224 to the VSIM server 250. For example, the mobile communication device 100 may contact the VSIM server 250 over the Internet via the VSIM network 220 using the previous PS connection for the VSIM 160.

The mobile communication device 100 may receive an authentication response 226 from the VSIM server 250 via the Internet 240 and the VSIM network 220 using the previous PS connection for the VSIM 160. The mobile communication device 100 may then transmit the authentication response to the VSIM network 220. Accordingly, tune away from the VSIM network 220 to a remote network (e.g., the remote network 440) is not required and the delay between sending the authentication request 222 in receiving the authentication response 226 is reduced.

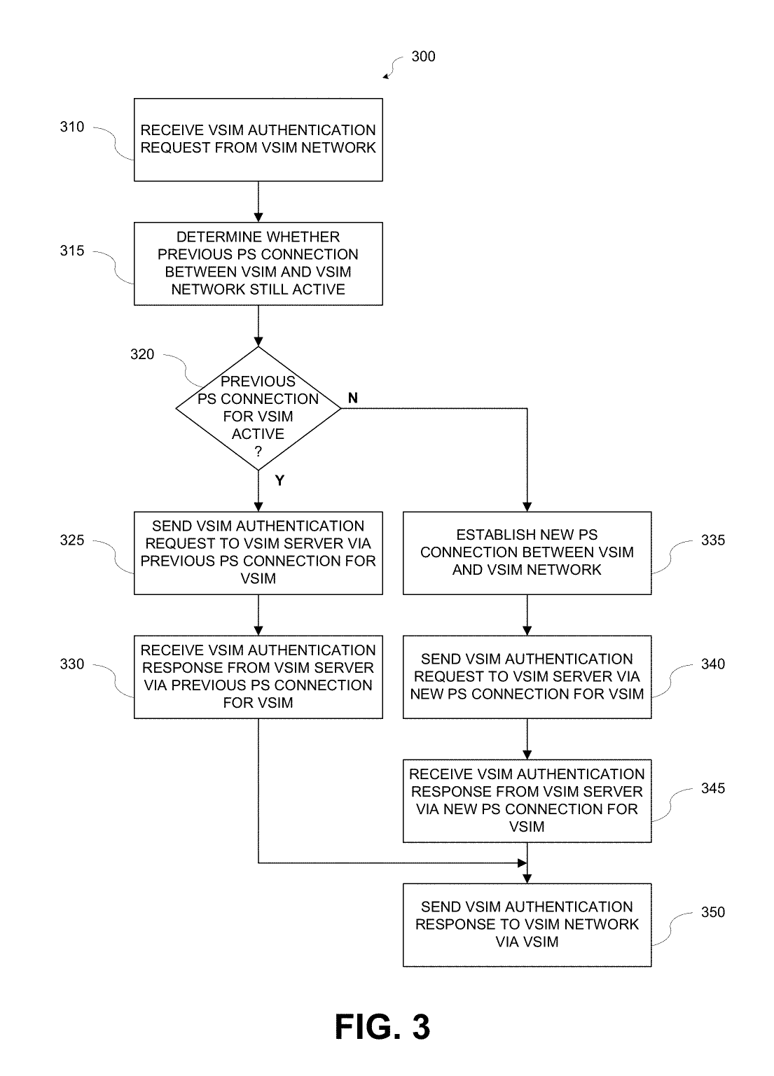

FIG. 3 is a flowchart illustrating a method 300 for remote authentication of a VSIM on a DSDS mobile communication device according to various examples. Referring to FIGS. 2 and 3, during mobility situations for the mobile communication device 100 after initial authentication of the VSIM 160, the VSIM network 220 may send an authentication request 224 to the mobile communication device 100. At block 310, the mobile communication device 100 may receive the authentication request 224 for the VSIM 160.

At block 315, the mobile communication device 100 may determine whether a previous PS connection for the VSIM 160 is still active. For example, the control unit 110 may control the communication unit 120 to attempt to “ping” (i.e., perform a handshake with) the VSIM server 250 to determine if the previous PS connection is still active. Alternatively, the control unit 110 may control the communication unit 120 to attempt to directly send the authentication request 224 to the VSIM server 250 via the previous PS connection for the VSIM and wait for a predetermined amount of time, for example, 100 mS or another amount of time, to receive a response.

In response to determining that the previous PS connection for the VSIM 160 is not still active (320-N), at block 335 the control unit 110 may control the VSIM 160 to establish a new PS connection. For example, the control unit 110 may control the VSIM 160 to establish a new PS connection between the VSIM 160 and the VSIM network 220 on a different subscription than the subscription on which the previous PS connection was established. At block 340, the control unit 110 may control the VSIM 160 and the communication unit 120 to send the authentication request 224 to the VSIM server 250 via the Internet 240 and the VSIM network 220 using the new PS connection for the VSIM 160.

At block 345, the mobile communication device 100 may receive an authentication response 226 from the VSIM server 250 via the Internet 240 and the VSIM network 220 using the new PS connection for the VSIM 160. At block 350, the mobile communication device 100 may then transmit the authentication response 226 to the VSIM network 220.

In response to determining that the previous PS connection for the VSIM 160 is still active (320-Y), at block 325 the mobile communication device 100 may use the previous PS connection for the VSIM 160 to transmit the authentication request 224 to the VSIM server 250. For example, the control unit 110 may control the communication unit 120 to contact the VSIM server 250 over the Internet 240 via the VSIM network 220 using the previous PS connection for the VSIM 160.

At block 330, the mobile communication device 100 may receive an authentication response 226 from the VSIM server 250 via the Internet 240 and the VSIM network 220 using the previous PS connection for the VSIM 160. At block 350, the mobile communication device 100 may then transmit the authentication response 226 to the VSIM network 220.

The method 300 may be embodied on a non-transitory computer readable medium, for example, but not limited to, the memory 180 or other non-transitory computer readable medium known to those of skill in the art, having stored therein a program including computer executable instructions for making a processor, computer, or other programmable device execute the operations of the methods.

The various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment.

The accompanying claims and their equivalents are intended to cover such forms or modifications as would fall within the scope and spirit of the protection. For example, the example apparatuses, methods, and systems disclosed herein can be applied to multi-SIM wireless devices subscribing to multiple communication networks and/or communication technologies. The various components illustrated in the figures may be implemented as, for example, but not limited to, software and/or firmware on a processor, ASIC/FPGA/DSP, or dedicated hardware. Also, the features and attributes of the specific example embodiments disclosed above may be combined in different ways to form additional embodiments, all of which fall within the scope of the present disclosure.

The foregoing method descriptions and the process flow diagrams are provided merely as illustrative examples and are not intended to require or imply that the operations of the various embodiments must be performed in the order presented. As will be appreciated by one of skill in the art the order of operations in the foregoing embodiments may be performed in any order. Words such as “thereafter,” “then,” “next,” etc., are not intended to limit the order of the operations; these words are simply used to guide the reader through the description of the methods. Further, any reference to claim elements in the singular, for example, using the articles “a,” “an,” or “the” is not to be construed as limiting the element to the singular.

The various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the various embodiments.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of receiver devices, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more exemplary aspects, the functions described may be implemented in hardware, software, firmware, or any combination thereof. If implemented in software, the functions may be stored as one or more instructions or code on a non-transitory computer-readable storage medium or non-transitory processor-readable storage medium. The operations of a method or algorithm disclosed herein may be embodied in processor-executable instructions that may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

Although the present disclosure provides certain example embodiments and applications, other embodiments that are apparent to those of ordinary skill in the art, including embodiments which do not provide all of the features and advantages set forth herein, are also within the scope of this disclosure. Accordingly, the scope of the present disclosure is intended to be defined only by reference to the appended claims.

What is claimed is:

1. A method for optimizing remote authentication of a virtual subscriber identity module (VSIM) for a multi-subscriber identity module (SIM) multi-standby (MSMS) mobile communication device, the method comprising:
receiving a VSIM authentication request from a VSIM network;
determining whether a previous packet switched (PS) connection between the VSIM and the VSIM network is available;
in response to determining that the previous PS connection between the VSIM and the VSIM network is available, performing VSIM authentication using the previous PS connection between the VSIM and the VSIM network.

2. The method of claim 1, wherein the performing VSIM authentication using the previous PS connection comprises:
sending the VSIM authentication request to a VSIM server via the previous PS connection between the VSIM and the VSIM network.

3. The method of claim 2, wherein the performing VSIM authentication using the previous PS connection further comprises:
receiving a VSIM authentication response from the VSIM server via the previous PS connection between the VSIM and the VSIM network.

4. The method of claim 3, further comprising:
sending the VSIM authentication response to the VSIM network via the VSIM.

5. The method of claim 1, wherein the determining whether a previous packet switched (PS) connection between the VSIM and the VSIM network is available comprises:
attempting to perform a handshake with a VSIM server via the previous PS connection between the VSIM and the VSIM network.

6. The method of claim 1, further comprising:
in response to determining that the previous PS connection between the VSIM and the VSIM network is not available, establishing a new PS connection between the VSIM and the VSIM network.

7. The method of claim 6, further comprising:
sending the VSIM authentication request to a VSIM server via the new PS connection between the VSIM and the VSIM network.

8. The method of claim 7, further comprising:
receiving a VSIM authentication response from the VSIM server via the new PS connection between the VSIM and the VSIM network.

9. A multi-subscriber identity module (SIM) multi-standby (MSMS) mobile communication device, comprising:
a communication unit;
at least one physical subscriber identity module (SIM);
a virtual subscriber identity module (VSIM); and
a control unit operably connected to the communication unit, the at least one physical SIM, and the VSIM, the control unit configured to:
receive a VSIM authentication request from a VSIM network;
determine whether a previous packet switched (PS) connection between the VSIM and the VSIM network is available;
in response to determining that the previous PS connection between the VSIM and the VSIM network is available, perform VSIM authentication using the previous PS connection between the VSIM and the VSIM network.

10. The MSMS mobile communication device of claim 9, wherein the control unit is further configured to, when performing the VSIM authentication using the previous connection, control the communication unit to send the VSIM authentication request to a VSIM server via the previous PS connection between the VSIM and the VSIM network.

11. The MSMS mobile communication device of claim 10, wherein the control unit is further configured to, when performing VSIM authentication using the previous PS connection, receive a VSIM authentication response from the VSIM server via the previous PS connection between the VSIM and the VSIM network.

12. The MSMS mobile communication device of claim 11, wherein the control unit is further configured to send the VSIM authentication response to the VSIM network via the VSIM.

13. The MSMS mobile communication device of claim 9, wherein the control unit is further configured to, when determining whether a previous packet switched (PS) connection between the VSIM and the VSIM network is available, control the communication unit to attempt to perform a handshake with a VSIM server via the previous PS connection between the VSIM and the VSIM network.

14. The MSMS mobile communication device of claim 9, wherein:
in response to determining that the previous PS connection between the VSIM and the VSIM network is not available, the control unit is further configured to control the communication unit to establish a new PS connection between the VSIM and the VSIM network.

15. The MSMS mobile communication device of claim 14, wherein the control unit is further configured to send the VSIM authentication request to a VSIM server via the new PS connection between the VSIM and the VSIM network.

16. The MSMS mobile communication device of claim 15, wherein the control unit is further configured to receive a VSIM authentication response from the VSIM server via the new PS connection between the VSIM and the VSIM network.

17. A non-transitory computer readable medium having stored thereon a program for causing one or more processors to execute a method for optimizing remote authentication of a virtual subscriber identity module (VSIM) for a multi-subscriber identity module (SIM) multi-standby (MSMS) mobile communication device, the program including operations comprising:
receiving a VSIM authentication request from a VSIM network;
determining whether a previous packet switched (PS) connection between the VSIM and the VSIM network is available;
in response to determining that the previous PS connection between the VSIM and the VSIM network is available, performing VSIM authentication using the previous PS connection between the VSIM and the VSIM network.

18. The non-transitory computer readable medium having stored thereon a program as defined in claim 17, wherein the performing VSIM authentication using the previous PS connection includes operations comprising:
sending the VSIM authentication request to a VSIM server via the previous PS connection between the VSIM and the VSIM network.

19. The non-transitory computer readable medium having stored thereon a program as defined in claim 18, wherein the performing VSIM authentication using the previous PS connection includes operations further comprising:
receiving a VSIM authentication response from the VSIM server via the previous PS connection between the VSIM and the VSIM network; and
sending the VSIM authentication response to the VSIM network via the VSIM.

20. The non-transitory computer readable medium having stored thereon a program as defined in claim 17, wherein the determining whether a previous packet switched (PS) connection between the VSIM and the VSIM network is available includes operations comprising:
attempting to perform a handshake with a VSIM server via the previous PS connection between the VSIM and the VSIM network.

21. The non-transitory computer readable medium having stored thereon a program as defined in claim 17, the operations further including:
in response to determining that the previous PS connection between the VSIM and the VSIM network is not available, establishing a new PS connection between the VSIM and the VSIM network.

22. The non-transitory computer readable medium having stored thereon a program as defined in claim 21, the operations further including:
sending the VSIM authentication request to a VSIM server via the new PS connection between the VSIM and the VSIM network.

23. The non-transitory computer readable medium having stored thereon a program as defined in claim 22, the operations further including:
receiving a VSIM authentication response from the VSIM server via the new PS connection between the VSIM and the VSIM network.

24. A multi-subscriber identity module (SIM) multi-standby (MSMS) mobile communication device, comprising:
means for receiving a VSIM authentication request from a VSIM network;
means for determining whether a previous packet switched (PS) connection between the VSIM and the VSIM network is available;
in response to determining that the previous PS connection between the VSIM and the VSIM network is available, means for performing VSIM authentication using the previous PS connection between the VSIM and the VSIM network.

25. The MSMS mobile communication device of claim 24, further comprising:
means for sending the VSIM authentication request to a VSIM server via the previous PS connection between the VSIM and the VSIM network.

26. The MSMS mobile communication device of claim 25, further comprising:
means for receiving a VSIM authentication response from the VSIM server via the previous PS connection between the VSIM and the VSIM network; and
means for sending the VSIM authentication response to the VSIM network via the VSIM.

27. The MSMS mobile communication device of claim 24, further comprising:
means for attempting to perform a handshake with a VSIM server via the previous PS connection between the VSIM and the VSIM network.

28. The MSMS mobile communication device of claim 24, further comprising:
in response to determining that the previous PS connection between the VSIM and the VSIM network is not available, means for establishing a new PS connection between the VSIM and the VSIM network.

29. The MSMS mobile communication device of claim 28, further comprising:
means for sending the VSIM authentication request to a VSIM server via the new PS connection between the VSIM and the VSIM network.

30. The MSMS mobile communication device of claim 29, further comprising:
means for receiving a VSIM authentication response from the VSIM server via the new PS connection between the VSIM and the VSIM network.
